(19) United States
(12) Patent Application Publication
(10) Pub. No.: US 2012/0096085 A1
(43) Pub. Date: Apr. 19, 2012

(54) COMMUNICATIONS SYSTEM INCLUDING INSTANT MESSAGE DEVICE CONTROL AND RELATED METHODS

(75) Inventors: Iljee Yoon, Mississauga (CA); Giyeong Son, Waterloo (CA); Andreea Manolescu, Mississauga (CA)

(73) Assignees: Province of Ontario, Canada), Waterloo (CA); Research In Motion Limited (a corporation organized under the laws of the

(21) Appl. No.: 12/904,667

(22) Filed: Oct. 14, 2010

(51) Int. Cl. G06F 15/16

(52) U.S. Cl. 709/204

(57) ABSTRACT

A communications system may include a control device having an instant message (IM) device contact associated therewith. The communications system may also include a control gateway having an IM gateway contact associated therewith and may be configured to communicate with a controllable device over a network. The control gateway may be configured to validate the IM device contact. The control device may be configured to communicate with the controllable device through the control gateway after validation and based upon the IM device contact and the IM gateway contact.

### TECHNICAL FIELD

The present disclosure relates to the field of communications, and, more particularly, to messaging systems and related methods.

### BACKGROUND

Home control and monitoring systems are becoming increasingly popular. More particularly, a home control and monitoring system may include a camera, for example, and may communicate over a network, for example, the Internet. The camera may be accessed over the network via the camera's network address and port number, for example. A home control and monitoring system may also include controllable lighting, for example.

A home control and monitoring system may be accessible or controlled over the network via a mobile wireless communications device, for example. More particularly, a mobile application loaded on the mobile wireless communications device may be associated with a device to be monitored or controlled. For example, a lighting control application may be associated with controllable lighting, while a camera monitoring application may be associated with a camera. Additionally, each mobile application may also be for a specific type or brand of mobile wireless communications device.

In other words, a single mobile application may only operate with a single type or brand of mobile wireless communications device and control only a single device. Thus, controlling multiple devices on multiple types or brands of mobile wireless communications devices may involve using a more than one application, and more particularly, more than one application on a single mobile wireless communications device.

### BRIEF DESCRIPTION OF THE DRAWINGS

FIG. 1 is a schematic diagram of a communications system in accordance with an exemplary embodiment.

FIG. 2 is a plan view of the control device of FIG. 1.

FIG. 3 is a schematic block diagram of the control gateway and a portion of the control device of FIG. 1.

FIG. 4 is a schematic block diagram of the control gateway and a portion of the control device according to another exemplary embodiment.

FIG. 5 is a flow diagram of a method of communication in accordance with an exemplary embodiment.

FIG. 6 is a flow diagram of a method of communication in accordance with another exemplary embodiment.

FIG. 7 is a schematic block diagram illustrating additional components that may be included in the control device of FIG. 1

### DETAILED DESCRIPTION OF THE PREFERRED EMBODIMENTS

The present description is made with reference to the accompanying drawings, in which various example embodiments are shown. However, many different example embodiments may be used, and thus the description should not be construed as limited to the example embodiments set forth herein. Rather, these example embodiments are provided so that this disclosure will be thorough and complete. Like numbers refer to like elements throughout, and prime notation is used to indicate similar elements in alternative embodiments.

According to an exemplary aspect, a communications system may include a control device having an instant message (IM) device contact associated therewith. The communications system may also include a control gateway having an IM gateway contact associated therewith and may be configured to communicate with a controllable device over a network. The control gateway may be configured to validate the IM device contact. The control device may be configured to communicate with the controllable device through the control gateway after validation and based upon the IM device contact and the IM gateway contact. Accordingly, the communications system may provide increased interoperability among controllable devices and increased security between a control device and a control gateway.

The control gateway may include a database of a plurality of validated IM device contacts. The control gateway may be configured to validate the IM device contact based upon one of the plurality of validated IM device contacts, for example. The control gateway may be configured to send a communications request to the control device based upon the IM device contact being added to the database of the plurality of validated IM device contacts.

The control gateway may be configured to send a notification to the control device that the IM device contact has been validated, for example. The control device may be configured to send a validation request to the control gateway.

The control device may be a mobile wireless control device, for example. The mobile wireless control device may include a wireless transceiver and a controller cooperating therewith to perform at least one wireless communications function. The communications system may further include an IM server configured to provide IM communications between the control gateway and the control device.

A method aspect is directed to a communications method. The method may include using a control gateway having an IM gateway contact associated therewith to communicate with a controllable device over a network, and validate an IM device contact associated with a control device, for example. The method may further include using the control device to communicate with the controllable device through the control gateway after validation and based upon the IM device contact and the IM gateway contact.

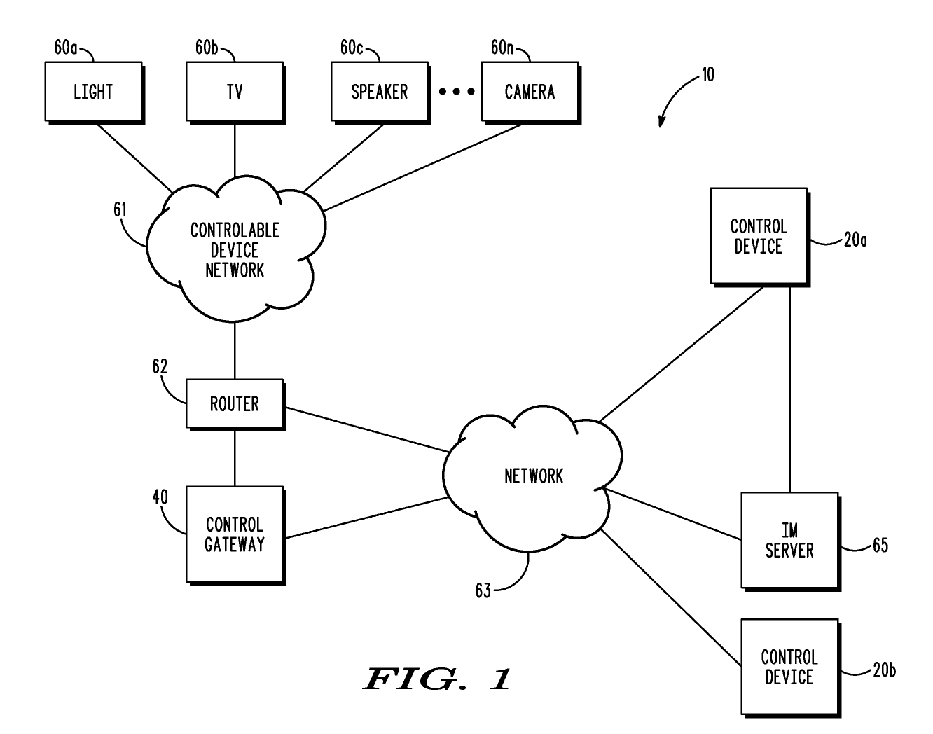

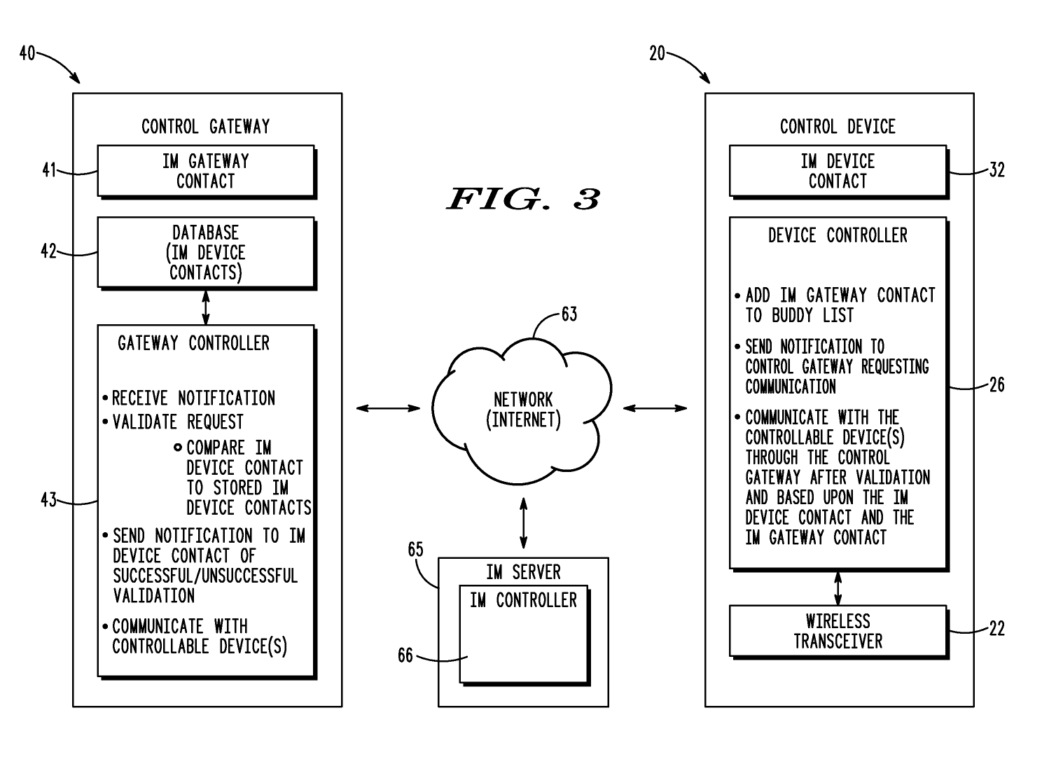

Referring initially to FIGS. 1-3, a communications system 10 illustratively includes control devices 20a, 20b. Illustratively, each control device 20 is a mobile wireless communications device and includes a housing 21. The control device 20 includes a display 23 carried by the housing 21 and an audio transducer 25 also carried by the housing. The audio transducer 25 may be a microphone, for example. The audio transducer 25 may also be a speaker. In some example embodiments, there may be more than one audio transducer 25, for example, a microphone and speaker may be used and carried by the housing 21.

The control device 20 includes one or more input devices 31. The input devices 31 illustratively include push buttons for cooperating with a controller 26. In some example embodiments, the input device 31 may be an alphanumeric keypad or other input device for cooperating with the controller 26, for example. Still further, an input device 31 (e.g. a button, a key, a trackball, an optical trackpad, a touchscreen, a thumbwheel, etc.) may be coupled to the display 23 to accept a touching input therefrom and cooperate with the controller 26.

The controller 26 is also carried by the housing 21 and cooperates with a wireless transceiver 22 to perform at least one mobile wireless communications function. For example, the wireless transceiver 22 may be a cellular transceiver or a WiFi transceiver, for example, and may cooperate with the controller 26 to communicate data and/or voice communications. Other types of wireless transceivers and mobile wireless communications functions will be appreciated by those skilled in the art.

The control device 20 has an instant message (IM) device contact 32 associated therewith. The IM device contact 32 may be provided by an IM device client, for example, Blackberry Messenger™, MSN Messenger™, and AOL Instant Messenger™. The IM device client may also cooperate with the controller 26 to provide an application programming interface (API) for receiving and sending data and commands to controllable devices 60a-60n. The IM device client may also provide an API for creating and accessing an IM session, for example, with another IM device contact.

The communications system 10 also includes a control gateway 40 having an IM gateway contact 41 associated therewith. The IM gateway contact 41 may be provided by an IM gateway client. The IM gateway client cooperates with a gateway controller 43 to provide an API that may set the control type and properties of the IM gateway contact 41. The control type and properties of the IM gateway contact 41 may include supported commands, parameters, and event subscription rules, for example, as will be appreciated by those skilled in the art. The control type may distinguish the IM gateway contact 41 from other types of IM contacts. For example, the control gateway 40 may set a particular IM control type that may identify the IM gateway contact as one that operates to control controllable devices.

The control gateway 40, and more particularly, the gateway controller 43, is configured to communicate with the controllable device 60a-60n. The controllable devices 60a-60n may each be a controllable power switch, light, speaker, door bell, camera, or other controllable device, for example.

The control gateway 40 may communicate with a selected one of the controllable devices 60a-60n over a controllable device network 61. The controllable device network 61 may be a wired network. Alternatively, the controllable device network 61 may be a wireless network, or a combination of wired and wireless networks. For example, the controllable device network 61 may be a local area network (LAN) located in a home and may include a one or more of a router 62, digital subscriber line (DSL) modem (not shown), or other networking device, as will be appreciated by those skilled in the art. The controllable device network 61 may be located in other locations, for example, a building, a dwelling, or other area near the controllable devices 60a-60n.

The control device 20, and more particularly, the controller 26, is configured to communicate with one or more of the controllable devices 60a-60n through the control gateway 40. As will be appreciated by those skilled in the art, the control gateway 40 may have its own internet address and may be accessible, or programmed, via a control panel, for example, a web browser. The control gateway 40 includes a database 42 of IN device contacts. The IM device contacts stored in the database 42 may be entered via the control panel, for example. As will be appreciated by those skilled in the art, the IM device contacts stored in the database 42 may be validated or considered “safe” IM contacts. Additionally, controllable device access permissions for each IM device contact stored in the database 42 may be set.

An IM server 65 that may include an IM server controller 66 may host or facilitate IM communications between IM contacts, for example, the IM device contact 32 and the IM gateway contact 41. The IM server 65 may be coupled to a network 63, for example, the Internet, and communicate with the control gateway 40 and the control device 20 over the Internet. Of course, the control device 20, the control gateway 40, and the TM server 65 may communicate over additional networks, or a combination of networks, for example, a cellular network, an internet protocol (IP) network, an internet service provider (ISP) network, a digital subscriber line (DSL) network, and a packet core network. Moreover, in some embodiments, the IM server functionality may be included in one or both of the control gateway 40 and the control device 20.

The IM device contact 32 invites communication with the IM gateway contact 41. The IM device contact 32 may invite communication by adding the IM gateway contact 41 to a list of IM contacts on the control device 20. The IM device contact 32 may send a notification, to the control gateway 40, requesting communication with the IM gateway contact 41. The request may include the identity of the IM device contact 32.

The control gateway 40, via the IM gateway contact 41, validates the request for communication by comparing the IM device contact 32 to the list of validated IM device contacts stored in the database 42 on the control gateway 40. Of course, validation may be performed using other identifiers.

As will be appreciated by those skilled in the art, the IM device contacts stored in the database 42 are considered safe or validated contacts, and by allowing communication with the contacts in the database, while excluding other IM device contacts, communications with the controllable devices 60a-60n may be limited to validated contacts. Thus, security may be increased.

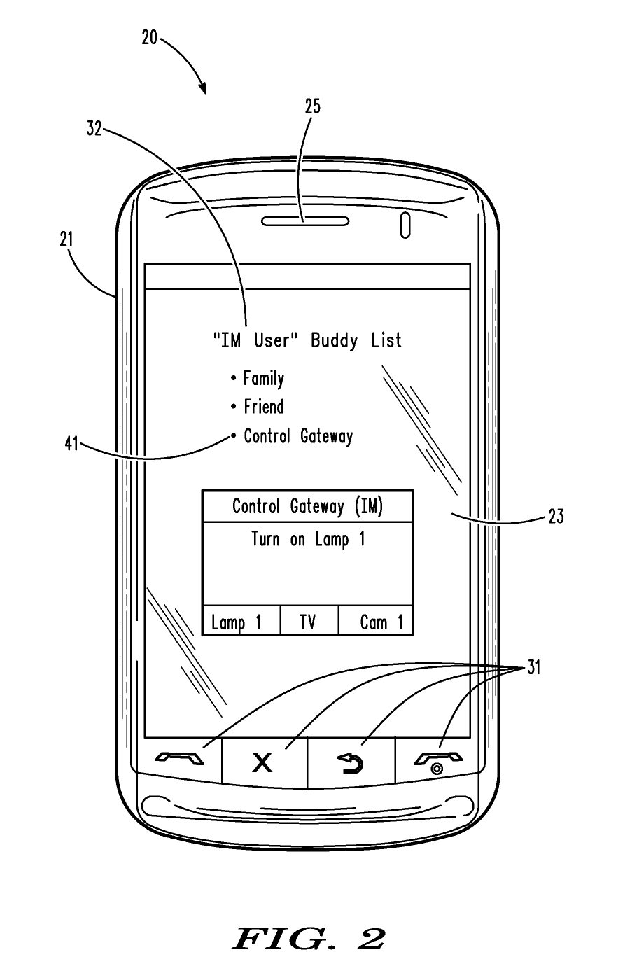

Based upon a successful validation, the control gateway 40, via the IM gateway contact 41, may send a notification message to the IM device contact 32 that the IM device contact has been validated. The notification message may include one or both of audio and video. For example, if the IM device contact 32 has been validated, the IM device contact may be notified by displaying the IM gateway contact 41 in the IM device contact's contact list or “buddy list” (FIG. 2). The IN gateway contact 41 is user selectable from among other contacts in the contact list. By selecting the IM gateway contact 41, the IM gateway contact's properties and available operations may be displayed. For example, operations to turn on and off a light may be displayed if the selected controllable device 60a-60n is a controllable light.

In contrast, if the IM device contact 32 is not validated, the IM gateway contact 41 is not added to the IM device contact's contact list. Moreover, the IN gateway 40 may send a notification, for example, a message via the IM gateway contact 41, that the IN device contact 32 cannot be validated, and communications therewith cannot be established.

Depending on the configuration, a single IM conversation or an IN conference may be initiated. An IM conversation or dialogue is opened by the IM device contact 32. The IM device contact 32 may view the notification message and send a command to the controllable devices 60a-60n via the IM gateway contact 41. For example, the commands may include view camera, turn on/off power, and start video/audio recording, for example. Other commands may be sent for controlling other ones of the controllable devices 60a-60n, as will be appreciated by those skilled in the art. The control gateway 40 returns execution results of the commands via the conversation between the IM gateway contact 41 and the IM device contact 32.

Available controllable devices 60a-60n appear in the dialogue or IM conversation, for example. Newly added controllable devices 60a-60n may appear as they are added and disappear as they are removed. The control gateway 40 returns execution results of the commands via the conversation between the IM gateway contact 41 and the IM device contact 32.

As will be appreciated by those skilled in the art, by using an IM infrastructure or protocol, the communications system 10 addresses interoperability issues between different control devices 20, client applications, and controllable devices 60a-60n. Moreover, by using an IM protocol, the communications system 10 may provide standardization of controllable device protocols and thus, may reduce the number of applications for communication and increase security.

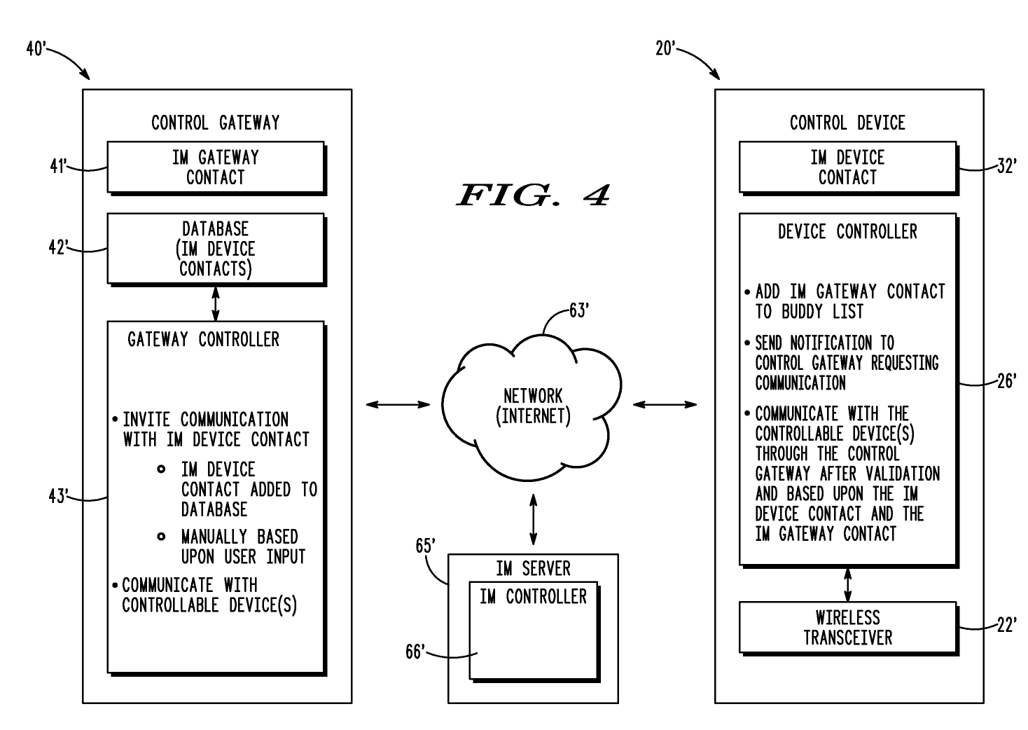

Referring now to FIG. 4, the IM gateway contact 41′ invites communication with an IM device contact 32′, for example, a family member or other trusted IM device contact. The control gateway 40′ may send a notification to the control device 20′ requesting communication with the IM gateway contact 41′ by being added to the list of contacts for communicating via the IM device contact 32′. The request may include the identity of the IM gateway contact 41′ and its properties, for example, that it is a control gateway.

The control gateway 40′ may send the invite notification based upon the IM device contact 32′ being added to the database 42′. Alternatively, or additionally, the control gateway 40′ may send the invite notification manually based upon user input, for example.

The invited IM device contact 32′ may accept the invitation. Upon acceptance, the IM gateway contact 41′ is added as a “buddy” or contact in the contact list for the IM device contact 32′. The IM gateway contact 41′ is user selectable from among other contacts in the contact list. By selecting the IM gateway contact 41′, the IM gateway contact's properties and available operations may be displayed. For example, operations to turn on and off a light may be displayed if the controllable device 60a′-60n′ is a controllable light.

During communications, the controllable devices 60a′-60n′, send a signal to the control gateway 40′. The control gateway 40′ initiates communications with the IM device contact 32′ by sending a notification message. The notification message may include one or both of audio and video. Depending on the configuration a single IM conversation or an IM conference may be initiated, and the IM device contact 32′ may also initiate communications.

An IM conversation or dialogue is opened by the IM device contact 32′. The IM device contact 32′ may view the notification and send a command to the controllable devices 60a′-60n′ via the IM gateway contact 41′. For example, the commands may include view camera, turn on/off power, and start video/audio recording, for example. Other commands may be sent for controlling other controllable devices, as will be appreciated by those skilled in the art. The control gateway 40′ returns execution results of the commands via the conversation between the IM gateway contact 41′ and the IM device contact 32′.

As will be appreciated by those skilled in the art, the communications system 10 advantageously increases interoperability between different products, for example, between the controllable devices 60a-60n and the control devices 20 of different brands. Moreover, security and reliability of communications with controllable devices 60a-60n may be increased while reducing the amount of infrastructure for communicating with the controllable devices. For example, by using an IM contact for contact management functionality, user authorization, and access control, the communications system 10 advantageously reduces configuration complexity allowing more efficient communications.

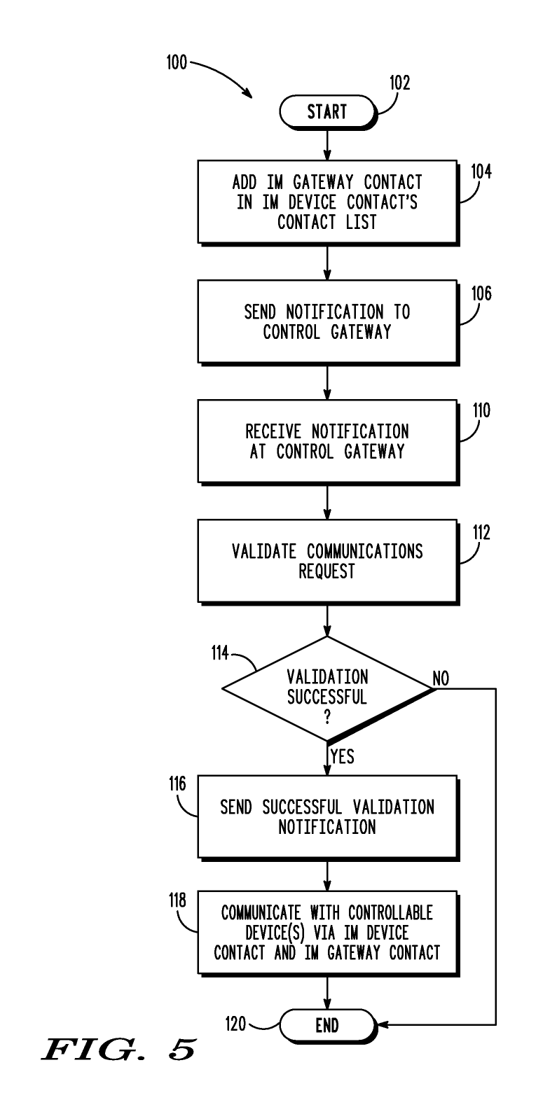

Referring now to the flowchart 100 in FIG. 5, a method of communication illustratively includes, beginning at Block 102, at a control device 20, adding an IM gateway contact 41 associated with a control gateway 40 to an IM device contact's contact list (Block 104). The control device 20 may send a notification to the control gateway 40 via the IM gateway contact 41 requesting communication therewith (Block 106). The control gateway 40 receives the notification (Block 110) and validates the communication request (Block 112). If validation is successful (Block 114), the control gateway 40 may send a notification to the IM device contact 32 indicating a successful validation (Block 116). Thereafter, the control device 20 communicates with the controllable devices 60a-60n through the control gateway 40 based upon the IM device contact 32 and the IM gateway contact 41 (Block 118). Alternatively, if the validation is unsuccessful, communications are not established. The method ends at Block 120.

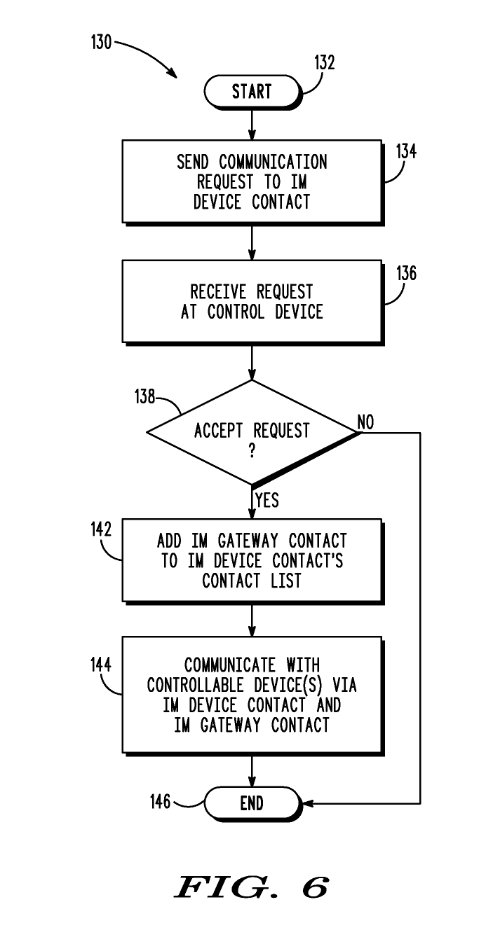

Referring now to the flowchart 130 in FIG. 6, a method of communication illustratively includes, beginning at Block 132, at a gateway controller 40, having an IM gateway contact 41 associated therewith, sending an invitation message requesting communication with an IM device contact 32 associated with a control device 20 (Block 134). The invitation message may be sent based upon one or both of the IM device contact 32 being added to a listing of IM device contacts in a database 42 and manually based upon input from a user. At Block 136, the control device 20, via the IM device contact 32, receives the invitation message, and if the invitation is accepted (Block 138), the IM gateway contact 41 is added to the IM device contact's contact list (Block 142). Thereafter, the control device 20 communicates with the controllable devices 60a-60n through the control gateway based upon the IM device contact 32 and the IM gateway contact (Block 144). Alternatively, if the validation is unsuccessful, communications are not established. The method ends at Block 146.

Additionally, the functionality of the communications system, including the functionality of the control device, the control gateway, for example, may be implemented using a combination of hardware (e.g., microprocessor, controller, etc.) and non-transitory computer readable medium components including computer-readable instructions for causing the various operations discussed herein to be performed.

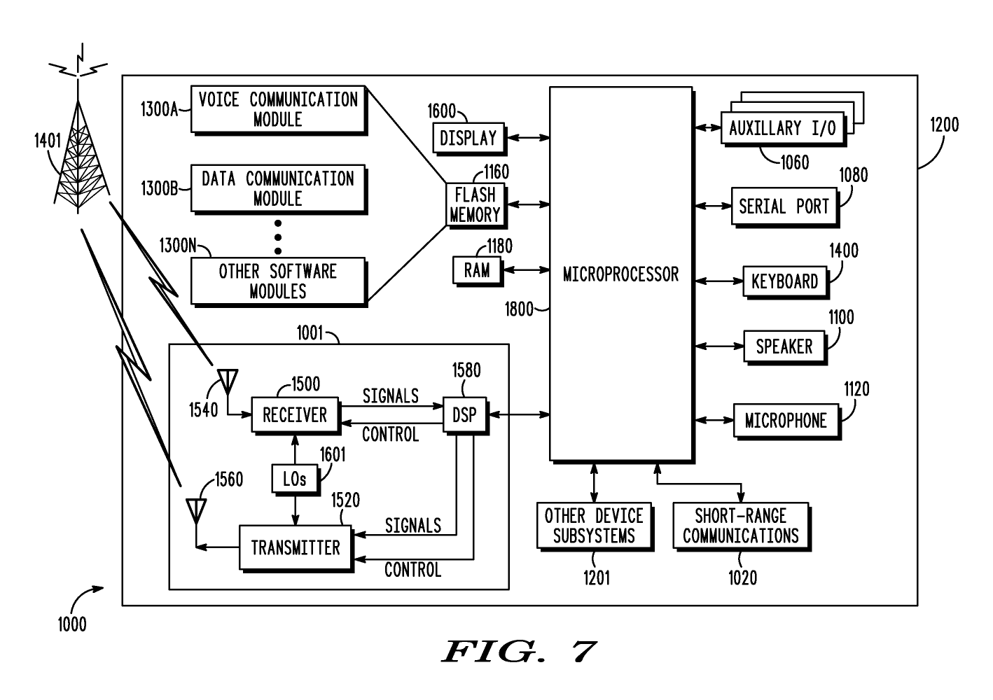

Exemplary components that may be used in various embodiments of the above-described control device are now described with reference to an exemplary mobile wireless communications device 1000 shown in FIG. 7. The device 1000 illustratively includes a housing 1200, a keypad 1400 and an output device 1600. The output device shown is a display 1600, which may comprise a full graphic LCD. In some embodiments, display 1600 may comprise a touch-sensitive input and output device. Other types of output devices may alternatively be utilized. A processing device 1800 is contained within the housing 1200 and is coupled between the keypad 1400 and the display 1600. The processing device 1800 controls the operation of the display 1600, as well as the overall operation of the mobile device 1000, in response to actuation of keys on the keypad 1400 by the user. In some embodiments, keypad 1400 may comprise a physical keypad or a virtual keypad (e.g., using a touch-sensitive interface) or both.

The housing 1200 may be elongated vertically, or may take on other sizes and shapes (including clamshell housing structures, for example). The keypad 1400 may include a mode selection key, or other hardware or software for switching between text entry and telephony entry.

In addition to the processing device 1800, other parts of the mobile device 1000 are shown schematically in FIG. 7. These include a communications subsystem 1001; a short-range communications subsystem 1020; the keypad 1400 and the display 1600, along with other input/output devices 1060, 1080, 1100 and 1120; as well as memory devices 1160, 1180 and various other device subsystems 1201. The mobile device 1000 may comprise a two-way RF communications device having voice and data communications capabilities. In addition, the mobile device 1000 may have the capability to communicate with other computer systems via the Internet.

Operating system software executed by the processing device 1800 may be stored in a persistent store, such as the flash memory 1160, but may be stored in other types of memory devices, such as a read only memory (ROM) or similar storage element. In addition, system software, specific device applications, or parts thereof, may be temporarily loaded into a volatile store, such as the random access memory (RAM) 1180. Communications signals received by the mobile device may also be stored in the RAM 1180.

The processing device 1800, in addition to its operating system functions, enables execution of software applications or modules 1300A-1300N on the device 1000, such as software modules for performing various steps or operations. A predetermined set of applications that control basic device operations, such as data and voice communications 1300A and 13003, may be installed on the device 1000 during manufacture. In addition, a personal information manager (PIM) application may be installed during manufacture. The PIM may be capable of organizing and managing data items, such as e-mail, calendar events, voice mails, appointments, and task items. The PIM application may also be capable of sending and receiving data items via a wireless network 1401. The PIM data items may be seamlessly integrated, synchronized and updated via the wireless network 1401 with the device user's corresponding data items stored or associated with a host computer system.

Communication functions, including data and voice communications, are performed through the communications subsystem 1001, and possibly through the short-range communications subsystem. The communications subsystem 1001 includes a receiver 1500, a transmitter 1520, and one or more antennas 1540 and 1560. In addition, the communications subsystem 1001 also includes a processing module, such as a digital signal processor (DSP) 1580, and local oscillators (LOs) 1601. The specific design and implementation of the communications subsystem 1001 is dependent upon the communications network in which the mobile device 1000 is intended to operate. For example, a mobile device 1000 may include a communications subsystem 1001 designed to operate with the Mobitex™, Data TACT™ or General Packet Radio Service (GPRS) mobile data communications networks, and also designed to operate with any of a variety of voice communications networks, such as AMPS, TDMA, CDMA, WCDMA, PCS, GSM, EDGE, etc. Other types of data and voice networks, both separate and integrated, may also be utilized with the mobile device 1000. The mobile device 1000 may also be compliant with other communications standards such as GSM, 3G, UMTS, 4G, etc.

Network access requirements vary depending upon the type of communication system. For example, in the Mobitex and DataTAC networks, mobile devices are registered on the network using a unique personal identification number or PIN associated with each device. In GPRS networks, however, network access is associated with a subscriber or user of a device. A GPRS device therefore utilizes a subscriber identity module, commonly referred to as a SIM card, in order to operate on a GPRS network.

When required network registration or activation procedures have been completed, the mobile device 1000 may send and receive communications signals over the communication network 1401. Signals received from the communications network 1401 by the antenna 1540 are routed to the receiver 1500, which provides for signal amplification, frequency down conversion, filtering, channel selection, etc., and may also provide analog to digital conversion. Analog-to-digital conversion of the received signal allows the DSP 1580 to perform more complex communications functions, such as demodulation and decoding. In a similar manner, signals to be transmitted to the network 1401 are processed (e.g. modulated and encoded) by the DSP 1580 and are then provided to the transmitter 1520 for digital to analog conversion, frequency up conversion, filtering, amplification and transmission to the communication network 1401 (or networks) via the antenna 1560.

In addition to processing communications signals, the DSP 1580 provides for control of the receiver 1500 and the transmitter 1520. For example, gains applied to communications signals in the receiver 1500 and transmitter 1520 may be adaptively controlled through automatic gain control algorithms implemented in the DSP 1580.

In a data communications mode, a received signal, such as a text message or web page download, is processed by the communications subsystem 1001 and is input to the processing device 1800. The received signal is then further processed by the processing device 1800 for an output to the display 1600, or alternatively to some other auxiliary I/O device 1060. A device user may also compose data items, such as e-mail messages, using the keypad 1400 and/or some other auxiliary I/O device 1060, such as a touchpad, a rocker switch, a thumb-wheel, or some other type of input device. The composed data items may then be transmitted over the communications network 1401 via the communications subsystem 1001.

In a voice communications mode, overall operation of the device is substantially similar to the data communications mode, except that received signals are output to a speaker 1100, and signals for transmission are generated by a microphone 1120. Alternative voice or audio I/O subsystems, such as a voice message recording subsystem, may also be implemented on the device 1000. In addition, the display 1600 may also be utilized in voice communications mode, for example to display the identity of a calling party, the duration of a voice call, or other voice call related information.

The short-range communications subsystem enables communication between the mobile device 1000 and other proximate systems or devices, which need not necessarily be similar devices. For example, the short-range communications subsystem may include an infrared device and associated circuits and components, or a Bluetooth™ communications module to provide for communication with similarly-enabled systems and devices.

Many modifications and other example embodiments of the present disclose will come to the mind of one skilled in the art having the benefit of the teachings presented in the foregoing descriptions and the associated drawings. Therefore, it is understood that the present disclosure is not to be limited to the specific example embodiments disclosed, and that modifications and example embodiments are intended to be included within the scope of the appended claims.

1. A communications system comprising:
a control device having an instant message (IM) device contact associated therewith; and
a control gateway having an IM gateway contact associated therewith and configured to communicate with a controllable device over a network, and validate the IM device contact, said control gateway comprising a database of a plurality of already validated IM device contacts;
said control device configured to communicate with the controllable device through said control gateway after validation and based upon the IM device contact and the IM gateway contact;
said control gateway configured to send a communications request to said control device based upon the IM device contact being added to the database of the plurality of already validated IM device contacts.

2. (canceled)

3. The communications system according to claim 1, wherein said control gateway is configured to validate the IM device contact based upon one of the plurality of already validated IM device contacts.

4. (canceled)

5. The communications system according to claim 1, wherein said control gateway is configured to send a notification to said control device that the IM device contact has been validated.

6. The communications system according to claim 1, wherein said control device is configured to send a validation request to said control gateway.

7. The communications system according to claim 1, wherein said control device comprises a mobile wireless control device.

8. The communications system according to claim 7, wherein said mobile wireless control device comprises a wireless transceiver and a controller cooperating therewith to perform at least one wireless communications function.

9. The communications system according to claim 1, further comprising an IM server configured to provide IM communications between said control gateway and said control device.

10. A communications sytem comprising:
a network;
a controllable device;
a control device having an instant message (IM) device contact associated therewith; and
a control gateway having an IM gateway contact associated therewith and configured to communicate with said controllable device over said network, and validate the IM device contact, said control gateway comprising a database of a plurality of already validated IM device contacts;
said control device configured to communicate with the controllable device over said network through said control gateway after validation and based upon the IM device contact and the IM gateway contact;
said control gateway configured to send a communications request to said control device based upon the IM device contact being added to the database of the plurality of already validated IM device contacts.

11. (canceled)

12. The communications system according to claim 10, wherein said control gateway is configured to send a notification to said control device that the IM device contact has been validated.

13. The communications system according to claim 10, wherein said control device is configured to send a validation request to said control gateway.

14. The communications system according to claim 10, further comprising an IM server configured to provide IM communications between said control gateway and said control device.

15. The communications system according to claim 10, wherein said network comprises a wireless network.

16. A control device having an instant message (IM) device contact associated therewith and comprising:
a control device controller configured to communicate with a control gateway having an instant message (IM) gateway contact associated therewith and configured to communicate with a controllable device over a network, and validate the IM device contact, the control gateway comprising a database of a plurality of already validated IM device contacts;
said control device controller configured to communicate with the controllable device through the control gateway after validation and based upon the IM device contact and the IM gateway contact;
said control device configured to receive a communications request from said control gateway based upon the IM device contact being added to the database of the plurality of already validated IM device contacts.

17. The control device according to claim 16, wherein said control device controller is configured to receive a notification from the control gateway that the IM device contact has been validated.

18. The control device according to claim 16, wherein said control device controller is configured to send a validation request to the control gateway.

19. The control device according to claim 16, further comprising a wireless transceiver cooperating with said control device controller to perform at least one wireless communications function.

20. The control device according to claim 16, wherein said control device controller is configured to communicate with an IM server configured to provide IM communications.

21. A communications method comprising:
using a control gateway having an IM gateway contact associated therewith to communicate with a controllable device over a network, and validate an IM device contact associated with a control device, the control gateway comprising a database of a plurality of already validated IM device contacts;
using the control device to communicate with the controllable device through the control gateway after validation and based upon the IM device contact and the IM gateway contact;
the communication also being based upon the control gateway sending a communications request to the control device based upon the IM device contact being added to the database of the plurality of already validated IM device contacts.

22. The method according to claim 21, further comprising using the control gateway to validate the IM device contact based upon being one of a plurality of validated IM device contacts stored in a database of the control gateway.

23. The method according to claim 22, further comprising using the control gateway to send a communications request to the control device based upon the IM device contact being added to the database of the plurality of validated IM device contacts.

24. The method according to claim 21, further comprising using the control gateway to send a notification to the control device that the IM device contact has been validated.

25. A communications method comprising:
using a control device to communicate with a controllable device through a control gateway over a network, the control gateway having an IM gateway contact associated therewith and comprising a database of a plurality of already validated IM device contacts;
the communication being based upon an IM device contact associated with the control device and the IM gateway contact and after validation from the control gateway
the communication also being based upon the control gateway sending a communications request to the control device based upon the IM device contact being added to the database of the plurality of already validated IM device contacts.

26. The method according to claim 25, further comprising using the control device to send a validation request to the control gateway.
